(19) United States
(12) Patent Application Publication
(10) Pub. No.: US 2003/0055984 A1
(43) Pub. Date: Mar. 20, 2003

(54) Entertainment system

(75) Inventors: Keiso Shimakawa, Kanagawa (JP); Shuji Hiramatsu, Tokyo (JP); Masakazu Suzuoki, Tokyo (JP); Akio Ohba, Kanagwa (JP); Toyoshi Okada, Tokyo (JP); Shigeru Enomoto, Kanagawa (JP); Muneki Shimada, Tokyo (JP); Tomokazu Kake, Tokyo (JP); Yousuke Kimoto, Kanagawa (JP); Kenjiro Komaki, Saitama (JP); Hiromasa Horie, Tokyo (JP); Takahiro Fujii, Tokyo (JP); Yuta Kimura, Tokyo (JP); Hidehisa Onai, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Computer Entertainment Inc., Tokyo (JP)

(21) Appl. No.: 10/146,345

(22) Filed: May 15, 2002

(30) Foreign Application Priority Data
May 18, 2001 (JP) 2001-150024
Mar. 26, 2002 (JP) 2002-086951

(51) Int. Cl. G06F 15/16; G06F 19/00; G06F 17/00; A63F 9/24; A63F 13/00

(52) U.S. Cl. 709/227; 709/205; 463/41; 463/42

(57) ABSTRACT

A communication device communicates information via a virtual world configured by a server machine to client terminal devices operating characters in the virtual world. It is therefore possible to transmit various information to and to receive various information from the virtual world, even from a place remote from the client terminal devices, which enables a linking between the virtual world and the real world to be realized.

### CROSS-REFERENCE TO RELATED APPLICATIONS

This application claims priority from Japanese Patent Application No. 2001-150024 filed on May 18, 2001, and No. 2002-086951 filed on Mar. 26, 2002, the disclosures of which are hereby incorporated by reference herein.

### BACKGROUND OF THE INVENTION

The present invention relates to an entertainment system, a communication system, a communication method, a computer-readable recording medium having recorded thereon a communication program, and the communication program, all of which are preferably to be applied to, for example, a multiplayer network game system in which a plurality of players log on to a server machine that constructs a virtual world on a network to play video games.

Conventionally, there has been in existence an entertainment system, that is, a multiplayer network game system, in which a server machine for processing and distributing various data on games and a plurality of client terminal devices are connected via a communication network, and a plurality of players operate the client terminal devices to play video games.

In this multiplayer network game system (hereinafter, referred to as a network game system), the server machine executes a game program to construct the virtual world, and individually processes information transmitted from a plurality of client terminal devices connected via the communication network. The server machine generates information necessary for execution and progress of individual games, and transmits the individually generated information to each client terminal device.

Here, information to be transmitted from the client terminal device to the server machine, for example, includes information on a position of a virtual character operated by the player within the virtual world and action information thereof. Further, information to be transmitted from the server machine to the client terminal device, for example, includes position or action data of other characters neighboring upon the character directly operated by the player (characters operated by other players).

However, in the foregoing network game system, when transmitting the information to and receiving the information from the virtual world or other characters, the player has to always connect the client terminal device and the server machine via the communication network.

Therefore, when the player is remote from the client terminal device or the client terminal device is not connected to the server machine, transmission of various information to and reception of various information from the virtual world such as, for example, a dialog with the other player via the character, cannot be conducted.

So far, a virtual world constructed by a network game system is a virtual space that is completely separated from the real world and is just a virtual space realized on the server machine, so that the virtual world and the real world cannot be linked with each other.

### SUMMARY OF THE INVENTION

The present invention has been made in view of the foregoing problems, and an object thereof is to provide an entertainment system, a communication system, a communication method, a computer-readable recording medium having recorded thereon a communication program, and the communication program, all of which are capable of linking a virtual world and a real world.

The present invention controls a bidirectional information communication process from a virtual world to a real world and from the real world to the virtual world. According to such a configuration, a user can transmit various information including sound information to the virtual world and receive various information including sound information from the virtual world wherever he/she is, so that the distance between the virtual world and the real world can be reduced, and the virtual world and the real world can be linked.

### BRIEF DESCRIPTION OF DRAWINGS

FIG. 1 is a schematic diagram showing the entire configuration of a network game system according to an embodiment of the present invention;

FIG. 2 is a flow chart showing an operation of the network game system shown in FIG. 1;

FIG. 3 is a flow chart showing another operation of the network game system shown in FIG. 1;

FIG. 4 is a schematic diagram showing a data format of a user database;

FIG. 5 is a schematic diagram showing a telephone number (access number) when voice communication is conducted;

FIG. 6 is a schematic diagram showing a telephone number (access number) when data communication is conducted;

FIG. 7 is a schematic diagram showing the entire configuration of a communication system according to the embodiment of the present invention;

FIG. 8 is a flow chart showing an operation of the communication system shown in FIG. 7; and

FIG. 9 is a flow chart showing an operation of another embodiment of the communication system shown in FIG. 7.

### DETAILED DESCRIPTION

First Embodiment

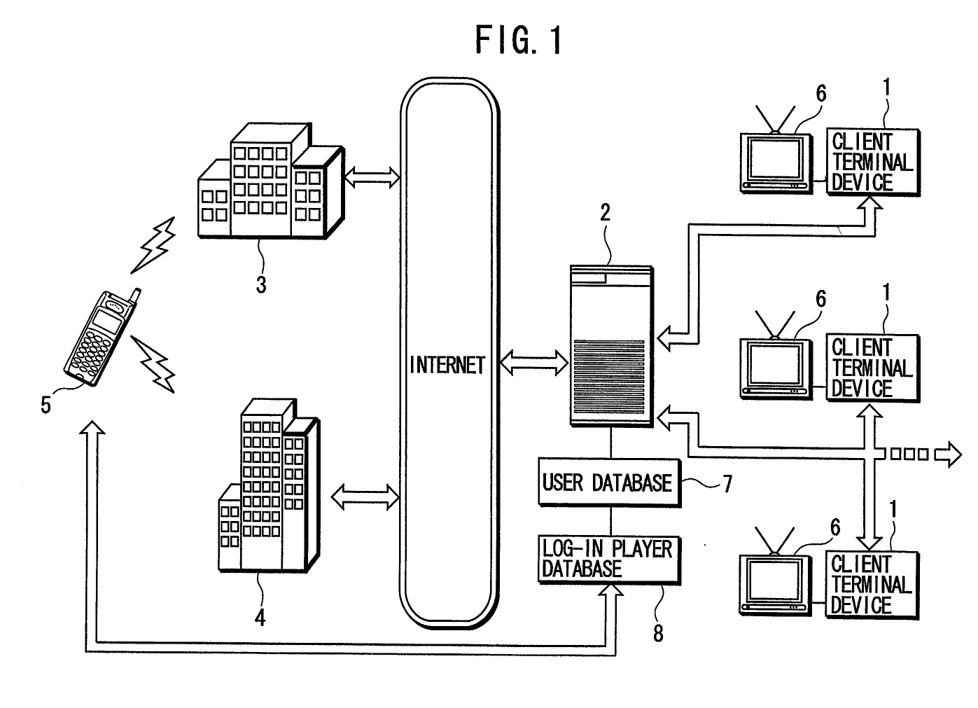

The present invention can be applied to a network game system in which a server machine and a plurality of client terminal devices are connected via a communication network and a plurality of players operate the client terminal devices and play in a virtual world constructed by the server machine, for example, as shown in FIG. 1.

Constitution of Network Game System

Firstly, with reference to FIG. 1, the entire configuration of a network game system according to an embodiment of the present invention will be explained.

The network game system according to the embodiment of the present invention is configured, as shown in FIG. 1, such that a plurality of client terminal devices 1 are connected via a server machine 2, the Internet, a telephone switching station 3, and an ISP 4 (Internet Service Provider: ISP) to a portable telephone 5.

Each client terminal device 1 is composed of a personal computer having a communication function or a video game machine having a communication function. To each client terminal device 1 is connected a controller for instructing various processes on a network game to the server machine 2, such as log-on to and log-off from the server machine 2 via a communication network, operation control of characters in the virtual world, information input, and the like. When the client terminal device 1 is a personal computer, an input device such as a keyboard, a mouse device or the like is utilized as the controller.

Each client terminal device 1 comprises a sound input device such as a microphone or the like, and a sound output device such as a speaker or the like so as to input and output sound information. Each client terminal device 1 is connected via electrical wiring to an output device 6. Each output device 6 outputs images or sound of the virtual world constructed by the server machine 2, images of characters in the virtual world, and the like in response to an instruction from the client terminal device 1. As the output device 6, for example, a display device or the like is utilized.

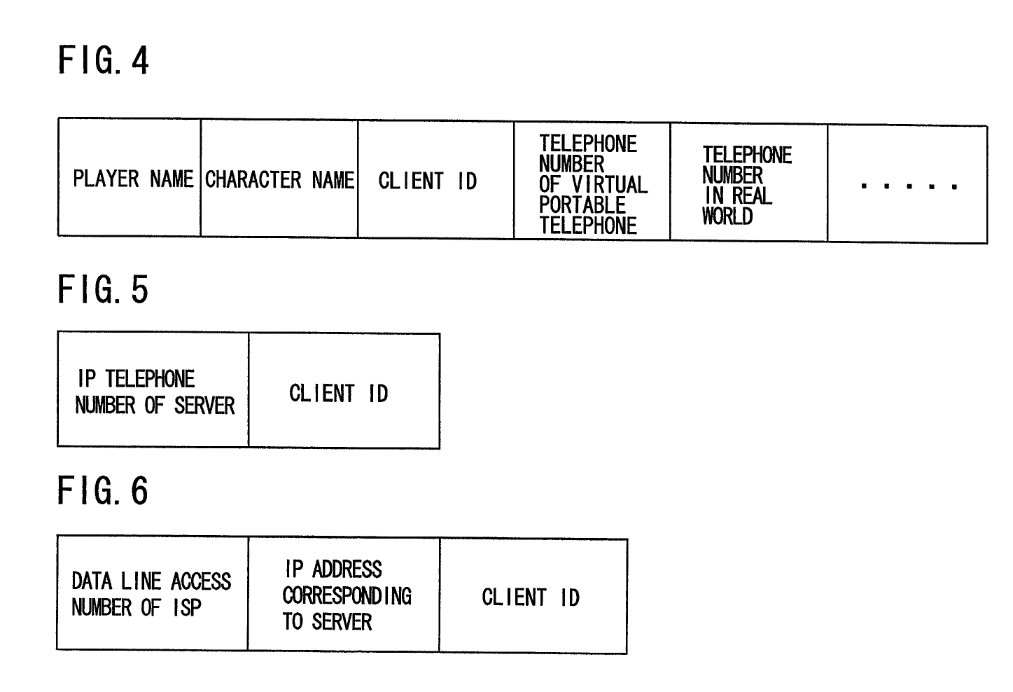

The server machine 2 comprises a user database 7 having stored therein information on the players participating in a network game, such as a player name, an identifier of the player (or the client terminal device 1) (hereinafter, referred to as client ID), a character name operated by the player, a telephone number of the portable telephone owned by the character, a portable telephone of the player in the data format as shown in FIG. 4, and a log-in player database 8 having stored therein the client IDs of the players logging on to the server machine 2.

The telephone switching station 3 comprises a VoIP (VoIP: Voice Over Internet Protocol, so-called Internet Phone) gateway for controlling voice communications between the server machine 2 and the portable telephone 5.

The ISP 4 comprises an Internet server machine for controlling data communications of voice mails, electronic mails and the like between the server machine 2 and the portable telephone 5.

The portable telephone 5 is connected via the telephone switching station 3 or the ISP 4 to the server machine 2. Here, when the server machine 2 per se has a function of conducting voice communications or data communications, the portable telephone 5 is directly connected to the server machine 2.

Communication Operation Between Characters in Virtual World

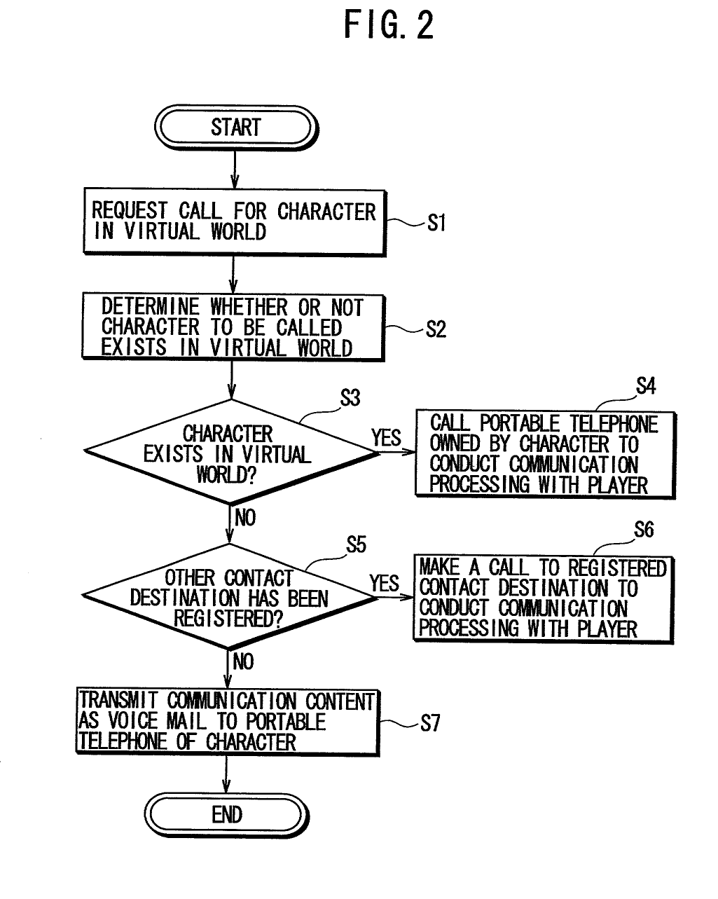

Next, with reference to the flow chart shown in FIG. 2, the operation of the network game system when a communication process is conducted between characters in the virtual world will be explained. In the following operation of the network game system, the server machine 2 constructs the virtual world in which each character in the virtual world has a name and holds a virtual portable telephone in order to communicate with other characters in the virtual world.

The flow chart shown in FIG. 2 starts when the player operates the client terminal device 1 to log on to the server machine 2 and the client terminal device 1 outputs to the output device 6 image and sound of the virtual world and a character image corresponding to the logged-on player which are transmitted from the server machine 2 via the communication network, and the communication process goes to the processing in step

In the processing in step S1, in response to an instruction from the player, the client terminal device 1 requests from the server machine 2 a call to another character in the virtual world. The communication process then goes from the processing in step S1 to the processing in step S2.

Note that the player operates the controller connected to the client terminal device 1 to conduct the processing in step S1. The server machine 2, when receiving a call request to a character from a player, transmits to the client terminal device 1 the image or sound indicating an action such that the character of the player who has requested the call (hereinafter, referred to as the calling party) utilizes his or her portable telephone and makes a call to the portable telephone owned by the other character. Thus, the server machine 2 can give the player the illusion that the player him/herself is making call in the virtual world, and it is possible to enhance the reality of the virtual world and the entertainment quality of the network game system.

In the processing in step S2, in response to a call request to the character from the player, the server machine 2 refers to the client ID stored in the log-in player database 8, and checks whether the player operating the character to be called has logged on to the server machine 2, to thereby determine whether the character to be called exists in the virtual world. If it is determined that the character to be called exists in the virtual world, the communication process goes to the processing in step S4.

In the processing in step S4, the server machine 2 transmits to the client terminal device 1 of the player operating the character to be called (hereinafter, referred to as the called party) the image and sound incoming in the portable telephone of the character operated by the called party. Thus, the called party can recognize the communication request. Hereinafter, the called party operates the controller of the client terminal device 1 to conduct voice communication or data communication via the portable telephone of the character operated by the calling party.

When the character operated by a third party is near the character operated by the calling party or the called party, the server machine 2 may transmit to the client terminal device 1 of the third party the image or sound indicating actions of the character operated by the calling party or the called party, such as, for example, the state in which the character operated by the calling party makes a call or the state in which the character operated by the called party talks over the telephone. According to such a configuration, the third party can confirm the communication process between those other players, and applications such as, for example, participating in a conversation between the calling party and the called party, or listening to the conversation, can be conducted, so that the reality of the virtual world can be more enhanced.

On the other hand, when the character to be called does not exist in the virtual world, the communication process goes to the processing in step S5.

In the processing in step S5, the server machine 2 refers to the user database 7 to determine whether a contact destination of the called party other than the telephone number of the portable telephone owned by the character has been registered in advance. If it is determined that the other contact destination has been registered, the communication process goes to the processing in step S6.

In the processing in step S6, the server machine 2 calls the called party to conduct voice communication or data communication directly or via the telephone switching station 3 or the ISP 4 with the registered contact destination. Thus, even when the character does not exist in the virtual world, the calling party in the virtual world can call the called party in the real world and conduct voice communication or data communication.

Since, when the contact destination registered in the user database 7 is the portable telephone 5 of the called party, the server machine 2 makes a call to the portable telephone 5 of the called party directly or via the telephone switching station 3 to call the called party, even when the called party is remote from the client terminal device 1 or the called party has not logged on to the server machine 2, voice communication can be conducted between the calling party and the called party. On the other hand, when the contact destination has not been registered, the communication process goes to the processing in step S7.

In the processing in step S7, the server machine 2 notifies the calling party that the called party is absent. The calling party transmits a voice message for the called party from the client terminal device 1 to the server machine 2 in response to receiving the absence notice from the server machine 2. The server machine 2 transmits the voice message as a voice mail to the portable telephone 5 held by the character corresponding to the called party. Thus, when the called party next logs on to the virtual world, the called party can recognize that a call request has been issued from the other player while the called party has been logged off, and can confirm the message from the calling party by opening the voice mail. Further, the calling party can reliably transmit the message even to a called party who has not logged on to the server machine 2.

In the foregoing processing, the character operated by the other player is called of the player's own will, but, for example, the character may call the player voluntarily operating the character per se or the other player. Thus, it is possible to give to the player an illusion that the character in the virtual world exists in the real world, such as, for example, by unexpectedly calling the player from the character in the virtual world.

Communication Operation from Real World to Virtual World

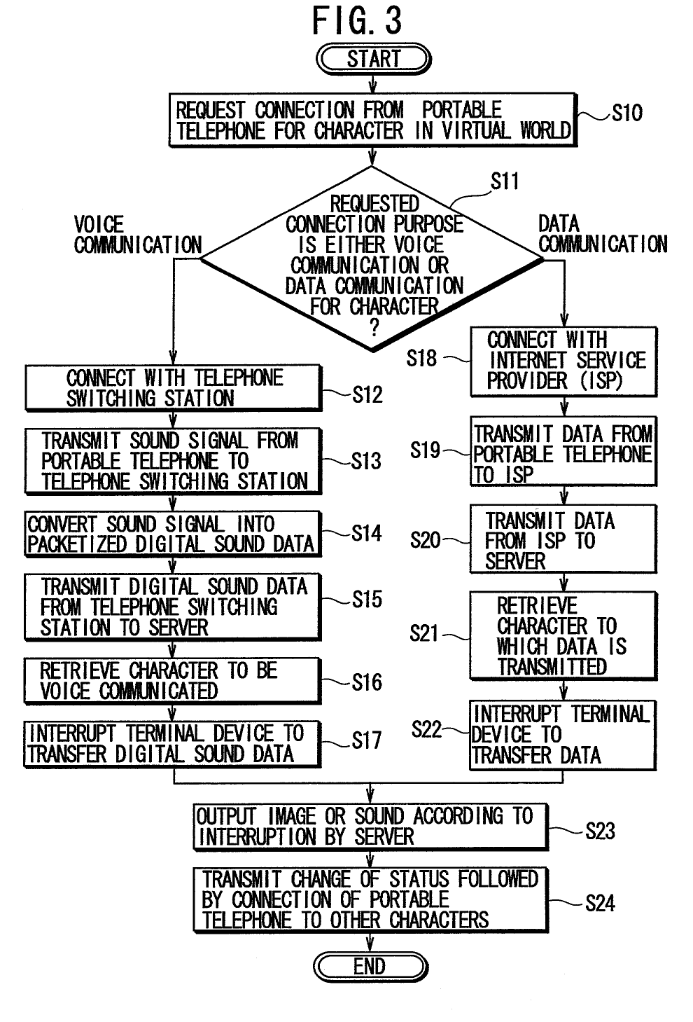

The operation of the foregoing network game system is not only the communication process between the characters in the virtual world, but may include communication, for example, from the real world to the virtual world. Hereinafter, with reference to FIG. 3, an operation of the network game system when the communication process is conducted from the real world to the virtual world will be explained.

The flow chart shown in FIG. 3 starts when the calling party turns ON the power supply of the portable telephone 5, and the communication process goes to the processing in step S10.

In the processing in step S10, the calling party utilizes the portable telephone 5 to output a request for voice communication or data communication for the character in the virtual world. The communication process then goes from the processing in step S10 to the processing in step S11.

Here, when requesting voice communication for the character in the virtual world, the calling party inputs the IP telephone number (IP: Internet Protocol) of the server machine 2 and the client ID to be called into the portable telephone 5. On the other hand, when requesting data communication for the character in the virtual world, the calling party inputs the data line access number to the ISP 4, the IP address corresponding to the server machine 2, and the client ID into the portable telephone 5. As data to be transmitted for the character, for example, various parameters in the virtual world, voice data or image data in digital form, and the like are employed.

In the processing in step S11, the portable telephone 5 refers to the information input by the calling party to determine whether the processing requested in step S10 is the transmission of voice communication or the transmission of data communication for the character. If it is determined that the requested processing is voice communication, the communication process goes to the processing in step S12.

In the processing in step S12, the portable telephone 5 makes a connection via the communication network with the telephone switching station 3, and transmits data in which the IP telephone number of the server machine 2 and information on the client ID of the client terminal device 1 to conduct the voice communication are packetized at the same time with the connection. The telephone switching station 3 refers to the IP telephone number of the server machine 2, and makes a VoIP connection via the Internet with the server machine 2. The communication process then goes from the processing in step S12 to step S13.

In the processing in step S13, the calling party inputs the voice for the character. The portable telephone 5 sequentially converts the sound input by the calling party into a sound signal to be transmitted to the telephone switching station 3. The communication process then goes from the processing in step S13 to step S14.

In the processing in step S14, the telephone switching station 3 converts the sound signal from the analog form transmitted from the portable telephone 5 into sound data in the digital form and adds a header thereto. The telephone switching station 3 converts the sound data in the digital form into an IP packet to form IP packetized sound data in the digital form (hereinafter, referred to as digital sound data). The communication process then goes from the processing in step S14 to the processing in step S15.

In the processing in step S15, the telephone switching station 3 transmits the digital sound data and the client ID attached thereto via the Internet to the server machine 2. The communication process then goes from the processing in step S14 to the processing in step S16.

In the processing in step S16, the server machine 2 compares the client ID transmitted from the portable telephone 5 with the client IDs stored in the log-in player database 8 to retrieve the character to conduct the voice communication (a player operating the character). The communication process then goes from the processing in step S16 to the processing in step S17. Here, in the processing in the foregoing step S16, as a result of the retrieval, when the character to conduct the voice communication does not exist in the virtual world, the user database 7 is referenced to call the other contact destination of the called party.

In the processing in step S17, the server machine 2 interrupts the client terminal device 1 of the player corresponding to the client ID, and transfers the digital sound data transmitted from the telephone switching station 3 to the client terminal device 1. The communication process then goes from the processing in step S17 to the processing in step S23.

On the other hand, when the requested processing is data communication, the communication process goes from the processing in step S11 to the processing in step S18.

In the processing in step S18, the portable telephone 5 makes a connection with the ISP 4 corresponding to the input data line access number, and transmits data to the ISP 4 in which the IP address corresponding to the server machine 2 and information on the client ID of the client terminal device 1 are packetized at the same time with the connection, as shown in FIG. 6. The ISP 4 refers to the IP address of the server machine 2, and connects with the server machine 2 via the Internet. The communication process then goes from the processing in step S18 to the processing in step S19.

In the processing in step S19, the player inputs the data to be transmitted for the character into the portable telephone 5, and the portable telephone 5 transmits the data to the ISP 4. The communication process then goes from the processing in step S19 to the processing in step S20.

In the processing in step S20, the ISP 4 attaches the client ID to the data transmitted from the portable telephone 5, and transmits the data as packet data to the server machine 2. The communication process then goes from the processing in step S20 to the processing in step S21.

In the processing in step S21, the server machine 2 refers to the client IDs stored in the log-in player database 8 and the client ID transmitted from the ISP 4 to retrieve the character corresponding to the client ID (a player operating the character). The communication process then goes from the processing in step S21 to the processing in step S22.

In the processing in step S22, the sever machine 2 interrupts the client terminal device 1 corresponding to the client ID, and transmits the data transmitted by the ISP 4 to the client terminal device 1. The communication process then goes from the processing in step S22 to the processing in step S23.

When voice communication and data communication are conducted for the character in the virtual world via the Internet from the portable telephone 5 in accordance with the processings in step S12 to step S17 or step S18 to step S22, the communication process goes to the processing in step S23.

In the processing in step S23, the client terminal device 1 outputs to the output device 6 the image or sound which corresponds to the information transferred from the server machine 2. Thus, when a voice communication is received, the calling party can conduct the communication process with sound between the portable telephone 5 and the client terminal device 1. Further, when a data communication is received, the client terminal device 1 can receive the data transmitted from the portable telephone 5. Thereafter, the communication process goes from the processing in step S23 to the processing in step S24.

In the processing in step S24, the server machine 2 transmits information on the change of the status of the character which conducts the voice communication or the data communication with portable telephone 5 (in this case, the fact that the voice communication or the data communication has been conducted via the portable telephone 5) to the client terminal device 1 of the player operating the other character. The information to be transmitted to the client terminal device 1 of the other player, for example, may include an image or the like in which the character operated by the player who has received the voice communication answers the telephone. Thus, the player can recognize that the other player is conducting a communication process, so that the series of processings is completed.

Second Embodiment

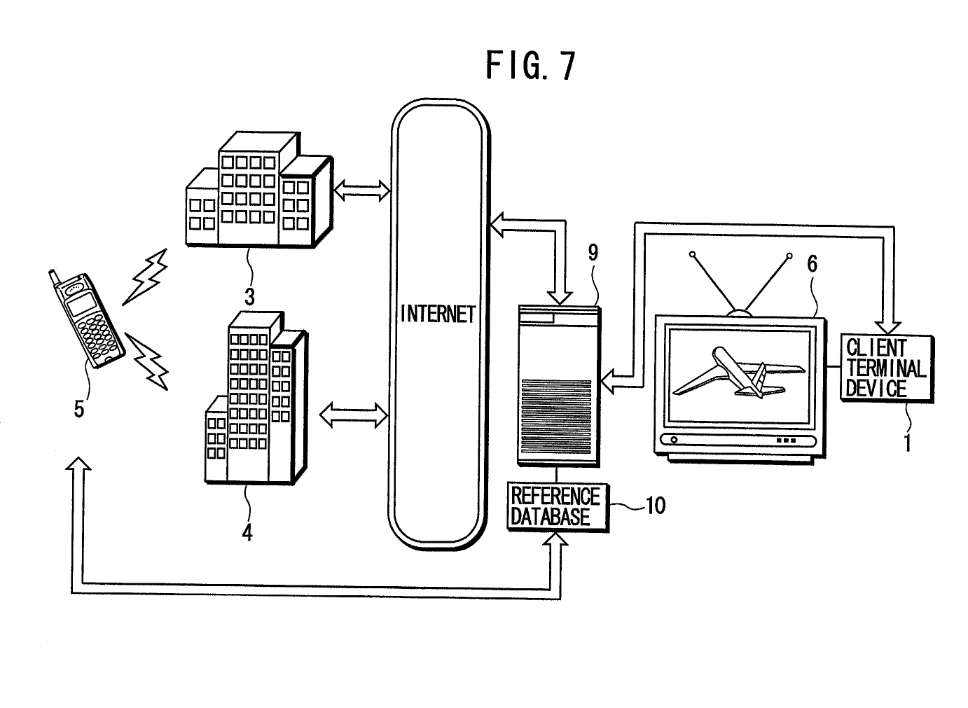

The present invention can be applied to a communication system composed of a dispatch server machine provided with an application program always executed on the client terminal device and a database for referring to the client terminal device connected to a communication network, for example, as shown in FIG. 7.

Configuration of Communication System

Firstly, with reference to FIG. 7, the entire configuration of a communication system according to this embodiment of the present invention will be explained.

The network game system according to this embodiment of the present invention is configured, as shown in FIG. 7, so that the client terminal device 1 is connected via a dispatch server machine 9, the Internet, the telephone switching station 3, and the ISP 4 to the portable telephone 5.

The client terminal device 1 always executes an application program (hereinafter, simply referred to as a program) without need for user input. Further, the output device 6 is connected to the client terminal device 1 via electrical wiring. The output device 6 outputs various information along with the execution of the program, such as the result of executing the program, error information and the like, in accordance with instructions from the client terminal device 1. An example of the foregoing program is a computer program for constructing the virtual world.

The telephone switching station 3 is provided with a VoIP gateway for controlling voice communications with the dispatch server machine 9.

The ISP 4 is provided with an Internet server machine for controlling data communications with the dispatch server machine 9.

The portable telephone 5 is connected via the telephone switching station 3 or the ISP 4 to the dispatch server machine 9. Further, the dispatch server machine 9 is connected via the Internet to the telephone switching station 3 or the ISP 4. Here, when the dispatch server machine 9 per se has a function of conducting voice communications or data communications, the portable telephone 5 is directly connected to the dispatch server machine 9.

The dispatch server machine 9 is directly connected to the telephone switching station 3 or the ISP 4 via the Internet. Further, the dispatch server machine 9 has a reference database 10 having recorded therein information on the identifiers of the client terminal devices 1 connected via the communication network or information on the programs executed on the client terminal devices 1.

Communication Operation from Portable Telephone to Application Program

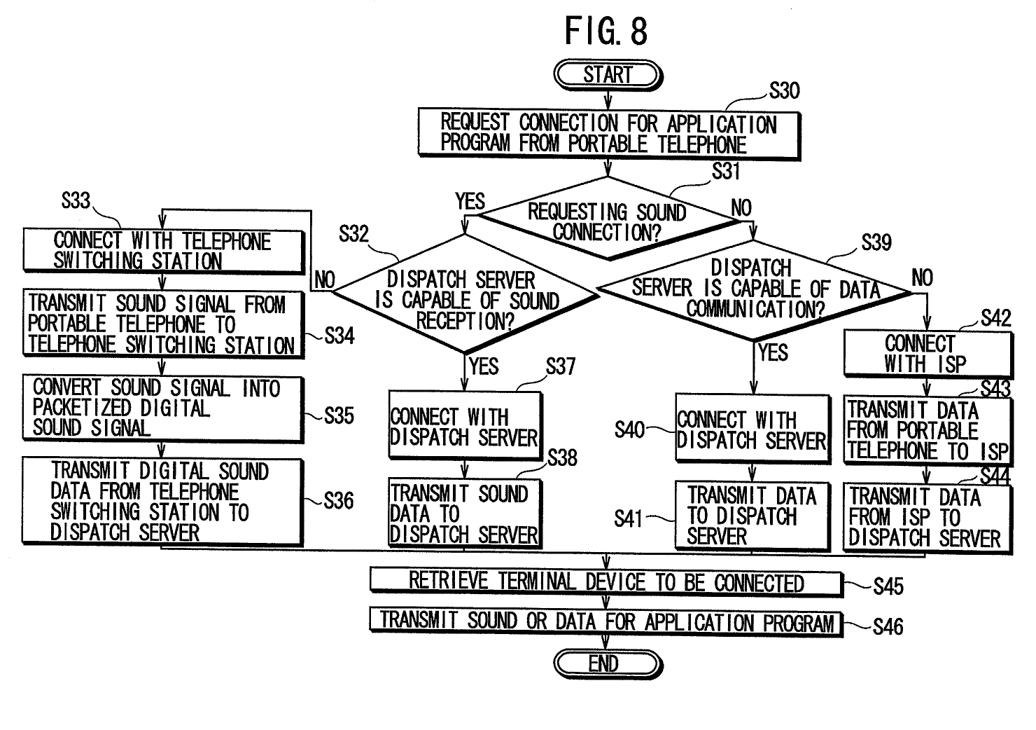

Next, with reference to the flow chart shown in FIG. 8, the operation of the foregoing communication system when a communication is conducted from the portable telephone to the application program will be explained.

The flow chart shown in FIG. 8 starts when the user turns ON the power supply of the portable telephone 5, and the communication process then goes to the processing in step S30.

In the processing in step S30, the user utilizes the portable telephone 5 to output a request to connect to the program executed on the client terminal device 1. The communication process then goes from the processing in step S30 to the processing in step S31.

In addition, when requesting a sound connection, the user inputs into the portable telephone 5 the IP telephone number of the dispatch server machine 9 and the identifier of the client terminal device 1 having the program to be connected. On the other hand, when requesting data communication for the program, the user inputs into the portable telephone 5 the data line access number to the ISP 4, the IP address of the dispatch server machine 9, and the identifier of the client terminal device 1 having the program to conduct the data communication. When the sound communication or the data communication can be directly conducted between the portable telephone 5 and the dispatch server machine 9, the user inputs the telephone number of the dispatch server machine 9 and the identifier of the client terminal device 1.

In the processing in step S31, the portable telephone 5 refers to the information input from the user to determinate whether the processing requested in step S30 is a sound connection or data communication for the program. If it is determined that the requested processing is a sound connection, the communication processing goes to the processing in step S32.

In the processing in step S32, the portable telephone 5 refers to the information input from the user to determine whether the dispatch server machine 9 can receive the sound.

For example, when the user inputs the telephone number of the dispatch server machine 9, the portable telephone 5 determines that the dispatch server machine 9 can receive the sound. On the other hand, when the user inputs the IP telephone number of the dispatch server machine 9, the portable telephone 5 determines that the dispatch server machine 9 cannot receive the sound.

If it is determined that the dispatch server machine 9 can receive the sound, the communication process goes to the processing in step S37. On the contrary, if it is determined that the dispatch server machine 9 cannot receive the sound, the communication process goes to the processing in step S33.

In the processing in step S33, the portable telephone 5 makes a connection with the telephone switching station 3, and transmits the IP telephone number of the dispatch sever machine 9 and the identifier of the client terminal device 1 at the same time. The telephone switching station 3 makes a VoIP connection with the dispatch server machine 9 via the Internet in accordance with the IP telephone number of the dispatch server machine 9. The communication process then goes from the processing in step S33 to step S34.

In the processing in step S34, the user inputs the sound for the program. The portable telephone 5 sequentially converts the contents of the sound input by the user into a sound signal and transmits the signal to the telephone switching station 3. The communication process then goes from the processing in step S34 to step S35.

In the processing in step S35, the telephone switching station 3 forms digital sound data from the sound signal in the analog form transmitted from the portable telephone 5. The communication process then goes from the processing in step S35 to step S36.

In the processing in step S36, the telephone switching station 3 transmits the digital sound data and the identifier of the client terminal device 1 attached thereto via the Internet to the dispatch server machine 9. The communication process then goes from the processing in step S36 to the processing in step S45.

In the processing in step S37, the portable telephone 5 refers to the telephone number of the dispatch server machine 9, makes a connection with the dispatch server machine 9, and transmits the identifier of the client terminal device 1 at the same time with the connection. The communication process then goes from the processing in step S37 to step S38.

In the processing in step S38, the user utilizes the portable telephone 5 to input the sound for the program. The portable telephone 5 sequentially converts the contents of the sound input by the user into sound data, and transmits the sound data to the dispatch server machine 9. The communication process then goes from the processing in step S38 to step S45.

On the other hand, when the requested processing is data communication, the communication process goes to the processing in step S39.

In the processing in step S39, the portable telephone 5 refers to the contents input from the user to determinate whether data communication can be directly conducted for the dispatch server machine 9.

For example, when the user inputs the telephone number of the dispatch server machine 9, the portable telephone 5 determines that data communication can be directly conducted with the dispatch server machine 9. On the other hand, when the data line access number to the ISP 4 and the IP address of the dispatch server machine 9 are input, the portable telephone 5 determines that data communication cannot be directly conducted with the dispatch server machine 9.

If it is determined that data communication can be directly conducted with the dispatch server machine 9, the communication process goes to the processing in step S40. On the contrary, when data communication cannot be directly conducted with the dispatch server machine 9, the communication process goes to the processing in step S42.

In the processing in step S40, the portable telephone 5 refers to the telephone number of the dispatch server machine 9, and makes a data connection to the dispatch server machine 9. The communication process then goes from the processing in step S40 to step S41.

In the processing in step S41, the user utilizes the portable telephone 5 to input the data for the program. The portable telephone 5 transmits the input data and the identifier of the client terminal device 1 to the dispatch server machine 9. The communication process then goes from the processing in step S41 to step S45.

In the processing in step S42, the portable telephone 5 makes a connection with the ISP 4 corresponding to the input data line access number, and transmits the IP address corresponding to the dispatch server machine 9 and the identifier of the client terminal device 1 to the ISP 4 at the same time. The ISP 4 refers to the IP address of the dispatch server machine 9, and makes a connection with the dispatch server machine 9 via the Internet. The communication process then goes from the processing in step S42 to the processing in step S43.

In the processing in step S43, the user inputs the data to be transmitted for the program into the portable telephone 5, and the portable telephone 5 transmits the data to the ISP 4. The communication process then goes from the processing in step S43 to the processing in step S44.

In the processing in step S44, the ISP 4 attaches the identifier of the client terminal device 1 to the data transmitted from the portable telephone 5, and transmits the data as packet data to the dispatch server machine 9. The communication process then goes from the processing in step S44 to the processing in step S45.

When the sound or the data is transmitted to the dispatch server machine 9 according to the foregoing processing, the communication process goes to the processing in step S45.

In the processing in step S45, the dispatch server machine 9 refers to the identifier stored in the reference database 10 and the transmitted identifier, and retrieves the client terminal device 1 to be connected. The communication process then goes from the processing in step S45 to the processing in step S46.

In the processing in step S46, the dispatch server machine 9 interrupts the program of the client terminal device 1 corresponding to the transmitted identifier, and transfers the transmitted sound or data to the program. This enables the user to conduct various controls with sound or data for the program executed on the client terminal device 1, so that the series of communication processings is completed.

Note that, when the portable telephone 5 is utilized to communicate with the program executed on the client terminal device 1, the dispatch server machine 9 may be configured to refer to the reference database 10 and transmit to the portable telephone 5 a list of the user names of the client terminal devices 1 connected via the communication network or the program names executed on the client terminal devices 1. According to such a configuration, it is possible for the user to refer to the contents of the list to, for example, communicate with the program of the other user or select a desired program from among a plurality of programs executed on one client terminal device.

Communication Operation from Application Program to Portable Telephone

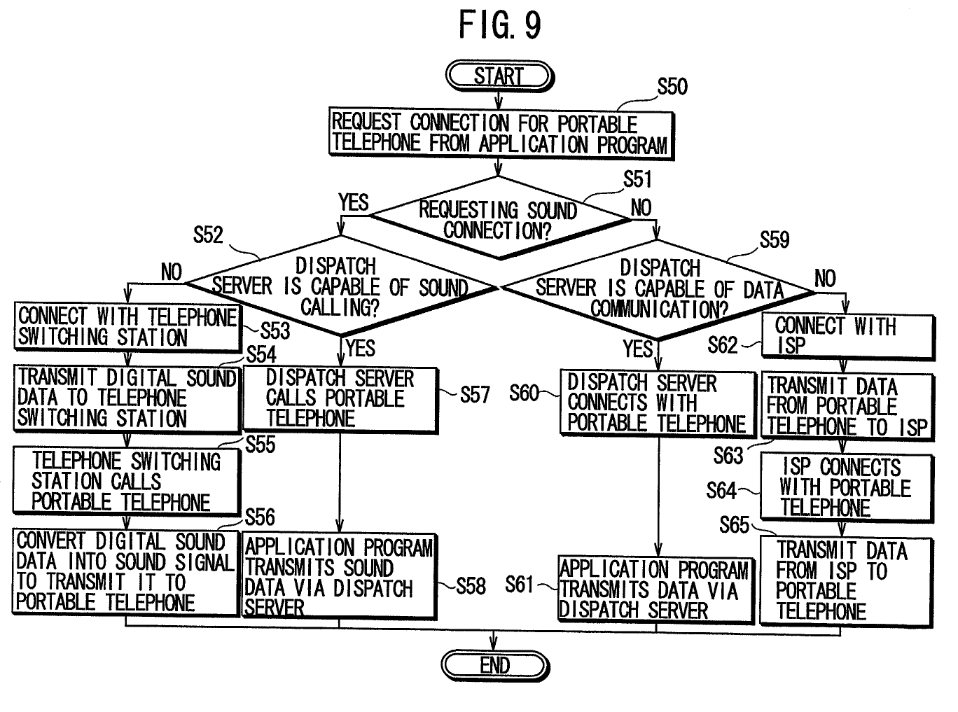

The operation of the foregoing communication system is not only the communication process from the portable telephone to the program, but the program may be configured so as to communicate with the portable telephone as necessary. Hereinafter, with reference to FIG. 9, an operation of the foregoing communication system when communication is conducted from the program to the portable telephone will be explained.

The flow chart shown in FIG. 9 starts when the program executed on the client terminal device 1 becomes a processing status set in advance, and the communication process goes to the processing in step S50. Here, as the processing status set in advance, for example, for an error time, a condition such as a predetermined elapsed time is provided.

In the processing in step S50, the client terminal device 1 outputs the connection request to the portable telephone 5 of the user registered in advance in the dispatch server machine 9. The communication process then goes from the processing in step S50 to the processing in step S51.

In the processing in step S51, the dispatch server machine 9 determinates whether the processing requested in step S50 is a sound connection or data communication for the portable telephone 5 of the user registered in advance. The processing in which the program makes a sound connection with the portable telephone 5 is used, for example, when digital sound data such as a program-having message is reproduced or when an alarm warning for the user in a remote place is issued. If it is determined that the requested processing is a sound connection, the communication process goes to the processing in step S52.

In the processing in step S52, it is determined whether the dispatch server machine 9 is capable of telephone calling. If it is determined that the dispatch server machine 9 is capable of telephone calling, the communication process goes to the processing in step S57. On the contrary, when telephone calling is not possible, the communication process goes to the processing in step S53.

In the processing in step S53, the dispatch server machine 9 makes a VoIP connection via the Internet with the telephone switching station 3. The communication process then goes from the processing in step S53 to step S54.

In the processing in step S54, the program transmits to the telephone switching station 3 the digital sound data and the telephone number of the portable telephone 5 to be called via the dispatch server machine 9. The communication process then goes from the processing in step S54 to step S55.

In the processing in step S55, the telephone switching station 3 calls the portable telephone 5. The communication process then goes from the processing in step S55 to step S56.

In the processing in step S56, the telephone switching station 3 converts the digital sound data into an analog sound signal to transmit the sound signal to the portable telephone 5, so that the series of processing steps is completed.

In the processing in step S57, the dispatch server machine 9 calls the portable telephone in accordance with the telephone number designated by the program. The communication process then goes from the processing in step S57 to step S58.

In the processing in step S58, the program transmits the sound data to the dispatch server machine 9. The dispatch server machine 9 transmits the sound data transmitted from the program to the portable telephone 5, so that the series of processing steps is completed.

On the other hand, when the requested processing is data communication, the communication processing goes to the processing in step S59.

In the processing in step S59, it is determined whether the dispatch server machine 9 is capable of data communication. If it is determined that the dispatch server machine 9 is capable of data communication, the communication process goes to the processing in step S60. On the contrary, when the dispatch server machine 9 is not capable of data communication, the communication process goes to the processing in step S62.

In the processing in step S60, the dispatch server machine 9 makes a connection with the portable telephone in accordance with the telephone number designated by the program. The communication process then goes from the processing in step S60 to step S61.

In the processing in step S61, the program transmits the data to the dispatch server machine 9. The dispatch server machine 9 transmits the data to the connected portable telephone 5, so that the series of processing steps is completed.

In the processing in step S62, the dispatch server machine 9 makes a connection with the ISP 4 via the Internet. The communication process then goes from the processing in step S62 to step S63.

In the processing in step S63, the program transmits to the dispatch server machine 9 the data and the telephone number of the portable telephone 5 to which the data is to be transmitted. The dispatch server machine 9 transmits via the Internet to the ISP 4 the data and the telephone number of the portable telephone 5 to which the data is to be transmitted. The communication process then goes from the processing in step S63 to step S64.

In the processing in step S64, the ISP 4 makes a connection with the portable telephone 5 in accordance with the telephone number transmitted by the program. The communication process then goes from the processing in step S64 to step S65.

In the processing in step S65, the ISP 4 transmits the digital data transmitted from the dispatch server machine 9 to the portable telephone 5. Thus, the series of processing steps is completed.

As is clear from the foregoing description, since, in the entertainment system and the communication system according to the embodiments of the present invention, the portable telephone can be utilized to conduct voice communication or data communication with a program executed in a remote place, the user can transmit/receive various information, including sound information, to/from the program wherever he/she is.

Further, since, when the program is a network game program provided by the server machine via the communication network, voice communication or data communication can be conducted between the virtual world realized with the network game program and the portable telephone in the real world, even when the user is remote from the client terminal device, the information can be transmitted to/received from the virtual world. This gives the player the illusion that the virtual world is the real world, and realizes a linking between the virtual world and the real world.

Furthermore, since, when the program is always executed on the client terminal device, voice communication or data communication can be conducted between the program and the portable telephone, even when the user is remote from the client terminal device, he/she can control the program. Further, it is possible to transmit from the program a message, such as an alarm warning to the user in a remote place. This enables a linking between the program and the user to be realized.

Further, since the entertainment system according to the embodiment of the present invention can conduct information communication with other characters in the virtual world via the virtual communication terminals respectively owned by the characters in the virtual world, it is possible to enhance the reality and entertainment quality of the network game system.

Other Embodiments

So far, the invention made by the present inventors has been described according to the foregoing embodiments. However, from the description and drawings which form part of the disclosure, various alternative embodiments, examples, and operation techniques will be apparent to those skilled in the art.

For example, in the foregoing embodiments, the portable telephone 5 is utilized to conduct the communication processing, but the present invention is not limited thereto, and any devices having a communication function can be employed, such as a portable information terminal (Personal Digital Assistants: PDA), a beeper, a transceiver, and the like.

Further, the operation of the communication system according to the foregoing embodiment may be programmed to be stored in a recording medium. The recording medium includes a computer-readable recording medium and the like capable of recording the programs, such as a semiconductor memory, a magnetic disk, an optical disk, a magnet-optical disk, a magnet tape and the like. When the communication operation is conducted, the communication process according to the embodiment of the present invention can be realized by causing a computer to read this recording medium, storing the program in a storage section, such as a memory in the computer system, and executing a communication program in a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An entertainment system, comprising:
a server machine for constructing a virtual world;
a plurality of terminal devices connectable via a communication network to the server machine and adapted for use by players to operate in the virtual world characters assigned to the players;
a log-in player database having stored therein identification information for the terminal devices;
a determination unit operable, in response to a request from a first player to communicate with a second player while the first player is operating a character, to determine whether the terminal device of the second player is connected to the server machine by referring to the log-in player database;
a calling unit operable to call a registered communication destination of the second player when the terminal device of the second player is not connected to the server machine; and
a communication unit operable to establish a first communication path between the terminal device of the first player and the communication destination when the communication destination responds to the call, and operable to establish a second communication path between the terminal device of the first player and the terminal device of the second player when the terminal device of the second player is connected to the server machine.

2. The entertainment system according to claim 1, further comprising:
a communication device connectable via a communication network to the server machine,
wherein, in response to a request from the communication device to communicate with a character being operated by the second player, the determination unit refers to the log-in player database to determine whether the terminal device of the second player is connected to the server machine, and
the communication unit is operable to establish a third communication path between the communication device and the terminal device of the second player when the terminal device of the second player is connected to the server machine

3. The entertainment system according to claim 1, further comprising:
a portable terminal device associated with each character in the virtual world,
wherein the server machine is operable to transmit to the terminal device of the second player an image and sound representing a call to the portable terminal device of the character operated by the second player when the terminal device of the second player is connected to the server machine.

4. The entertainment system according to claim 1, wherein, when the communication destination does not respond to the call, the server machine is operable to receive communication content from a communication request source, to convert the communication content into a voice mail, and to transmit the voice mail to the character operated by the second player.

5. The entertainment system according to claim 2, wherein sound information communicated between the server machine and the communication device is converted to packetized digital data prior to being communicated.

6. A communication system, comprising:
a plurality of terminal devices for constructing a virtual world;
a server machine connected via a communication network to the terminal devices; and
a communication device connectable via a communication network to the server machine and operable to communicate sound information and digital information via the server machine to the virtual world.

7. The communication system according to claim 6, wherein
the server machine includes a database having stored therein identification information for the terminal devices;
the communication device is operable to transmit to the server machine identification information of the terminal devices to be communicated with; and
the server machine is operable to refer to the transmitted identification information and the identification information stored in the database to establish a communication path between the communication device and the terminal devices to be communicated with.

8. The communication system according to claim 6, wherein the virtual world transmits sound information via the server machine to the communication device in response to a predetermined processing status.

9. The communication system according to claim 6, wherein the sound information communicated between the server machine and the communication device is converted to packetized digital data prior to being communicated.

10. A communication method, comprising:
determining whether a character exists in a virtual world in response to a request from a source to communicate with the character;
establishing a first communication path between the request source and a terminal device of a player operating the character when the character exists in the virtual world;
placing a call to a communication destination registered by the player operating the character when the character does not exist in the virtual world; and
establishing a second communication path between the request source and the communication destination when the communication destination responds to the call.

11. The communication method according to claim 10, wherein each character in the virtual world has a portable terminal device, the method further comprising:
transmitting to the terminal device of the player operating the character an image and sound representing a call to the portable terminal device of the character when the character exists in the virtual world.

12. The communication method according to claim 10, further comprising:
when the communication destination does not respond to the call, receiving communication content from the request source, converting the content into a voice mail, and transmitting the voice mail to the character.

13. The communication method according to claim 10, further comprising:
converting sound information into packetized digital data and communicating the packetized digital data to the communication destination.

14. A communication method, comprising:
receiving an identifier of a terminal device;
establishing a communication path with a virtual world constructed on the terminal device; and
communicating sound information and digital information with the virtual world via the communication path.

15. The communication method according to claim 14, further comprising:
converting the sound information into packetized digital data prior to communicating the sound information with the virtual world.

16. A computer-readable recording medium having recorded thereon a communication program to be executed on a computer, the communication program comprising:
determining whether a character exists in a virtual world in response to a request from a source to communicate with the character;
establishing a first communication path between the request source and a terminal device of a player operating the character when the character exists in the virtual world;
placing a call to a communication destination registered by the player operating the character when the character does not exist in the virtual world; and
establishing a second communication path between the request source and the communication destination when the communication destination responds to the call.

17. The computer-readable recording medium according to claim 16, wherein each character in the virtual world has a portable terminal device, the communication program further comprising:
transmitting to the terminal device of the player operating the character an image and sound representing a call to the portable terminal device of the character when the character exists in the virtual world.

18. The computer-readable recording medium according to claim 16, wherein the communication program further comprises:
when the communication destination does not respond to the call, receiving communication content from the request source, converting the content into a voice mail, and transmitting the voice mail to the character.

19. The computer-readable recording medium according to claim 16, wherein the communication program further comprises:
converting sound information into packetized digital data and communicating the packetized digital data to the communication destination.

20. A computer-readable recording medium having recorded thereon a communication program to be executed on a computer, the communication program comprising:
receiving an identifier of a terminal device;
establishing a communication path with a virtual world constructed on the terminal device; and
communicating sound information and digital information with the virtual world via the communication path.

21. The computer-readable recording medium according to claim 16, wherein the communication program further comprises:
converting the sound information into packetized digital data prior to communicating the sound information with the virtual world.

22. A system for performing communication, comprising:
a processor for executing instructions; and
instructions, the instructions including:
determining whether a character exists in a virtual world in response to a request from a source to communicate with the character;
establishing a first communication path between the request source and a terminal device of a player operating the character when the character exists in the virtual world;
placing a call to a communication destination registered by the player operating the character when the character does not exist in the virtual world; and
establishing a second communication path between the request source and the communication destination when the communication destination responds to the call.

23. A system for performing communication, comprising:
a processor for executing instructions; and
instructions, the instructions including:
receiving an identifier of a terminal device;
establishing a communication path with a virtual world constructed on the terminal device; and
communicating sound information and digital information with the virtual world via the communication path.
